(19) United States
(12) Patent Application Publication
(10) Pub. No.: US 2026/0081359 A1
(43) Pub. Date: Mar. 19, 2026

(54) MODULAR FABRICATION DEVICE AND METHOD FOR CABLE-MEMBRANE STRUCTURE OF THIN MEMBRANE REFLECTOR ANTENNA

(71) Applicant: Xidian University, Xi'an (CN)

(72) Inventors: Jingli DU, Xi'an (CN); Bin ZI, Xi'an (CN); Yiqun ZHANG, Xi'an (CN); Xuechao DUAN, Xi'an (CN); Shuxin ZHANG, Xi'an (CN); Feijie WANG, Xi'an (CN); Dongwu YANG, Xi'an (CN); Zhiwei REN, Xi'an (CN)

(73) Assignee: Xidian University, Xi'an (CN)

(21) Appl. No.: 19/326,630

(22) Filed: Sep. 11, 2025

Related U.S. Application Data
(63) Continuation of application No. PCT/CN2025/078885, filed on Feb. 24, 2025.

(30) Foreign Application Priority Data
Sep. 13, 2024 (CN) 2024112863227

(51) Int. Cl. H01Q 15/14; G01C 3/02; G01L 1/00; H01Q 1/12

(52) U.S. Cl. CPC H01Q 15/141; G01C 3/02; G01L 1/005; H01Q 1/12

(57) ABSTRACT

Disclosed are a modular fabrication device and method for a cable-membrane structure of a thin membrane reflector antenna. The device includes a triangular cable net shaping device mounted on a worktable, where the triangular cable net shaping device is provided with a linear motion assembly, a planar motion assembly, a cantilever assembly, and positioning pins, the cantilever assembly is provided with a cable net tension adjustment device, and the positioning pins are provided with tension measurement devices; a triangular cable net unit is wound around the positioning pins and tensioned into a triangle; and the worktable is provided with distance measurement devices configured to measure distances of cable segments of the triangular cable net unit, and a cable pressing device. The triangular cable net unit is pasted to a thin membrane, and a modular triangular cable-membrane structural unit is formed.

### CROSS-REFERENCE TO RELATED APPLICATIONS

The application claims priority to Chinese patent application No. 2024112863227, filed on Sep. 13, 2024, the entire contents of which are incorporated herein by reference.

### TECHNICAL FIELD

The present disclosure belongs to the technical field of thin membrane antennas, and relates to a modular fabrication device and modular fabrication method for a cable-membrane structure of a thin membrane reflector antenna.

### BACKGROUND

A thin membrane reflector antenna, a type of high-precision reflector antenna, primarily consists of a basic support structure, a cable net structure, and a reflector. The cable net structure is divided into a front cable net, a rear cable net, and a vertical cable. A plurality of triangular structures are formed on a front net surface. The reflector is divided into a plurality of triangular membranes that are laid on the front cable net surface, so that an integral cable-membrane structure is formed.

Traditionally, the cable-membrane structure needs to be fabricated separately. First, each cable segment is cut out according to a designed length of the cable segment and designed tension inside the cable. Then, the cable segments are woven into an integral cable net manually. Finally, triangular membranes having a designed size are cut out and pasted to a basic cable net structure in sequence. Thus, integral fabrication of the cable-membrane structure is completed.

An existing fabrication method still has various shortcomings. Firstly, the interchangeability is far from satisfactory because the cable-membrane structure is taken as an integral structure, adjacent triangular membranes share one cable, and thus when one cable segment or triangular membrane is to be replaced, all surrounding structures need to be disassembled. Secondly, a process of manually weaving a great number of cable segments of the cable net structure into the net according to a topological relation of the cable net is messy and complicated. Thirdly, the thin membranes need to be cut into pre-designed triangles, and then pasted to the cable net structure in sequence. In consequence, it is difficult to paste adjacent edges of the adjacent triangular thin membranes uniformly, ensure flatness of a surface after pasting, or match a shape of the cable net because the electrode membrane is pasted after the construction of the basic cable net structure of an antenna and laid and pasted in a suspended state. Due to these defects, a fabricated antenna prototype deviates from design results, which brings inconvenience to prototype experiments. Thus, it is necessary to propose a fabrication solution for the thin membrane reflector antenna, so as to solve the above problems without switching a worktable.

### SUMMARY

To solve the above shortcomings in the prior art, an objective of the present disclosure is to provide a modular fabrication device for a cable-membrane structure of a thin membrane reflector antenna. Thus, a lack of interchangeability, a complicated fabrication process, an undesirable fabrication effect, etc. in the prior art are solved.

The present disclosure is implemented through the technical solution as follows:

In an aspect, the present disclosure provides a modular fabrication device for a cable-membrane structure of a thin membrane reflector antenna. The device includes:
a worktable configured to fix a triangular cable net shaping device, and positioning pins penetrating a tabletop and configured to tension a cable;
the triangular cable net shaping device configured with a linear motion assembly, a planar motion assembly, and a cantilever assembly, and configured to shape the cable of a triangular cable net unit;
the triangular cable net unit wound around the positioning pins of the triangular cable net shaping device through the cable separately, and tensioned into a triangular cable net having balanced tension;
a cable net tension adjustment device fixed to the triangular cable net shaping device, and configured to provide a traction force and adjustment tension for the cable net of the triangular cable net unit;
tension measurement devices fixed to the worktable and the linear motion assembly of the triangular cable net shaping device respectively, and configured to measure cable tension in an X-axis direction and a Y-axis direction of the worktable through tension measurement sensors;
distance measurement devices fixed to the worktable and the triangular cable net shaping device respectively, and configured to measure distances of cable segments of the triangular cable net unit;
a cable pressing device configured to position the cable and lock the cable to cable rings of the positioning pins for the cable net of the triangular cable net unit; and
a thin membrane and an adhesive tape, configured to paste the triangular cable net unit fabricated and form a modular triangular cable-membrane structural unit.

Preferably, the worktable includes a first tabletop and a third tabletop distributed in a stepped shape, a second tabletop is arranged below a front side of the first tabletop, the first tabletop is provided with a through hole and an elongated slot parallel to a direction X of the worktable, and adjustable ground feet are arranged at a bottom of the worktable.

Preferably, the linear motion assembly of the triangular cable net shaping device is fixed to a second tabletop of the worktable and located exactly below the elongated slot, and is parallel to a slot channel; the planar motion assembly is fixed to a third tabletop of the worktable, and a first sliding table is arranged on the planar motion assembly; and the planar motion assembly is vertically connected to the cantilever assembly, and the cantilever assembly extends out from the planar motion device, and is laid on an upper surface of a first tabletop of the worktable.

Preferably, the planar motion assembly includes a second sliding table, a horizontal-axis assembly, a pair of vertical-axis assemblies, and a synchronous motion rod; the one pair of vertical-axis assemblies are fixed to a third tabletop of the worktable in parallel in a direction parallel to a direction Y of the worktable; the horizontal-axis assembly spans two vertical-axis assemblies in a direction perpendicular to a first vertical-axis assembly; the second sliding table is slidably connected to the horizontal-axis assembly; and the synchronous motion rod is connected to tail ends of the one pair of vertical-axis assemblies.

Preferably, the cantilever assembly includes a J-shaped extension rod member, a top plate of the J-shaped extension rod member is placed on a first tabletop, a bottom plate of the J-shaped extension rod member is connected to a second sliding table of the planar motion assembly, a fixing head is arranged at a tail end of the top plate of the J-shaped extension rod member, and the positioning pins configured to tension the cable penetrate the fixing head.

Preferably, the cable net tension adjustment device is arranged at one side of the cantilever assembly, and the cable net tension adjustment device is connected to a second cable end clamp through a traction device, so as to clamp the cable and pull the cable in a direction Y of the worktable.

Preferably, each of one pair of tension measurement devices is provided with a tension measurement sensor and the positioning pin configured to tension the cable, a first tension measurement device is located on a first tabletop, and a second tension measurement device is mounted on a sliding table of the linear motion assembly; and a first positioning pin and a second positioning pin are located at tops of the tension measurement devices, the first positioning pin is positioned and mounted through a through hole of the first tabletop, and the second positioning pin is limited in an elongated slot of the first tabletop, so as to limit linear movement of the second positioning pin.

Preferably, the distance measurement devices include distance sensors and reflective targets in three pairs; a first distance sensor is mounted on a first sliding table of the linear motion assembly, and a first reflective target is fixed to the first tension measurement device; a second distance sensor and a third distance sensor are mounted on a fixing head at a tail end of the cantilever assembly separately without interference, and a second reflective target is mounted on an edge of a front side of the first tabletop, and is parallel to a direction X of the worktable; a third reflective target is arranged on an edge of a left side of the first tabletop, and is parallel to a direction Y of the worktable; and lengths of three cable segments of the triangular cable net unit are obtained by measuring distances between the distance sensors and the reflective targets respectively.

Preferably, the cable of the triangular cable net unit is wound around the positioning pins in an external winding mode or a crossed winding mode.

In another aspect, the present disclosure provides a modular fabrication method for the modular fabrication device for a cable-membrane structure of a thin membrane reflector antenna. The method includes:
adjusting adjustable ground feet, and enabling a worktable to be in a horizontal state;
controlling coordinated motion of a linear motion assembly and a planar motion assembly of a triangular cable net shaping device according to actually-measured data of distance measurement devices separately, enabling a second positioning pin and a third positioning pin to move, adjusting lengths of cable segments of a triangular cable net unit along with a first positioning pin, and shaping the triangular cable net unit;
winding a cable around three positioning pins, and forming a triangular cable net;
performing, by a cable net tension adjustment device, tensioned traction on the triangular cable net unit under the control of a power source, determining that each cable segment reaches set tension according to a tension measurement sensor, and positioning and locking, by a cable pressing device, a cable to cable rings of the positioning pins for the cable net;
cutting off redundant cable ends from two ends of the cable, keeping a tensioned state of the triangular cable net, and completing fabrication of the triangular cable net unit; and
pasting the triangular cable net unit fabricated, and forming a modular triangular cable-membrane structural unit.

By employing the above technical solution, the present disclosure has the beneficial effects as follows:
1. A triangular cable-membrane structural unit module fabricated through the method of the present disclosure can be used to replace an electrode surface unit of the thin membrane reflector antenna. An electrode surface of the antenna is composed of a plurality of triangular cable-membrane structural units. When one triangular cable-membrane structural unit is damaged, mismatched in size, or loosened, the unit module needs to be replaced, and thus modular fabrication and replacement are achieved.
2. The plurality of triangular cable-membrane structural units on the electrode surface of the antenna are different in shape and size. With the method of the present disclosure, triangles different in shape and size can be determined only by controlling the linear motion assembly and the planar motion assembly. Thus, the device of the present disclosure has high versatility.
3. For the triangular cable-membrane structural unit fabricated through the method of the present disclosure, the accuracy of the shapes and sizes of the triangles is ensured in real time through three distance sensors in a fabrication process, and the above beneficial effect is achieved through a triangular shaping device. The accuracy of the tension of the three cable segments is ensured through two biaxial tension measurement sensors, and the above beneficial effect is achieved through the cable net tension adjustment device. In addition, the thin membrane is flatly pasted and cut after tensioning of the triangular cable net unit is determined, so that the thin membrane is in an accurately-flattened state in a use process. A qualified product having the accurate shape, size, and tension can be obtained through the method of the present disclosure.
4. The triangular cable-membrane structural unit fabricated through the method of the present disclosure has three sides corresponding to cable segment numbers generated when the electrode surface of the antenna is designed. According to an existing fabrication method for an electrode surface, each cable segment is independent of one another, each triangular thin membrane is independent of one another, and thus mistaken number exchange is likely to be caused when the cable segments are integrally woven into the electrode surface. Compared with the existing fabrication method for the electrode surface, the unit module fabricated is provided with an integrally-formed cable net unit that is systematically combined, and thus disorder, mistaken numbers, etc. are avoided, and each cable-membrane structural unit is provided with an independent triangular cable net unit and an independent triangular membrane. When the cable-membrane structural units are woven into the net, only connection between modules is required. Thus, confusion about numbers of the cable segments is avoided, and a process of assembling the electrode surface is simplified.
5. The device according to the method of the present disclosure has simplicity and high efficiency. The triangular cable net unit can be fabricated on one worktable, and the triangular cable-membrane structural unit module can be fabricated by laying, pasting and cutting out the thin membrane without replacing the worktable. Thus, the efficiency of fabrication of an antenna prototype is improved.

### BRIEF DESCRIPTION OF DRAWINGS

The accompanying drawings described herein are used for providing further understanding of the present disclosure as a constituent part of the present disclosure, instead of limiting the present disclosure improperly. In the figures:

FIG. 1 is a schematic structural diagram of a device of the present disclosure;

FIG. 2 is a schematic structural diagram of a worktable of the present disclosure;

FIG. 3 is a top view of a triangular cable net shaping device of the present disclosure;

FIG. 4 is a schematic structural diagram of a cable net tension adjustment device of the present disclosure;

FIG. 5 is a schematic structural diagram of a first tension measurement device of the present disclosure;

FIG. 6 is a schematic structural diagram of a second tension measurement device of the present disclosure;

FIG. 7 is a schematic structural diagram of a distance measurement device of the present disclosure;

FIG. 8 is a schematic structural diagram of a triangular cable net unit in an external winding mode of the present disclosure;

FIG. 9 is a schematic structural diagram of a triangular cable net unit in a crossed winding mode of the present disclosure;

FIG. 10 is a schematic structural diagram of a pressing device of the present disclosure; and

FIG. 11 is a schematic diagram of a process of fabricating a triangular cable-membrane structure of the present disclosure.

In the figures: 1, worktable; 101, first tabletop; 102, second tabletop; 103, third tabletop; 104, adjustable ground foot; 101-1, through hole; and 101-2, elongated slot;
2, triangular cable net shaping device; 201, linear motion assembly; 202, planar motion assembly; 203, cantilever assembly; 201-1, first sliding table; 202-1, second sliding table; 202-2, horizontal-axis assembly; 202-3, first vertical-axis assembly; 202-4, second vertical-axis assembly; 202-5, synchronous motion rod; 203-1, bottom plate of J-shaped extension rod member; 203-2, top plate of J-shaped extension rod member; 203-3, fixing head; 203-4, first cable end clamp; 203-5, fixed pulley; 204, first positioning pin; 205, second positioning pin; and 206, third positioning pin;
3, cable net tension adjustment device; 301, traction device; 302, fixing frame; and 303, second cable end clamp;
4, tension measurement device; 401, first tension measurement device; 402, second tension measurement device; 401-1, first tension measurement sensor; 401-2, fixing support; 402-1, second tension measurement sensor; and 402-2, fixing base;
5, triangular cable net unit; 501, first cable segment; 502, second cable segment; and 503, third cable segment;
6, distance measurement device; 601, first distance measurement device; 602, second distance measurement device; 603, third distance measurement device; 601-1, first distance sensor; 601-2, first reflective target; 602-1, second distance sensor; 602-2, second reflective target; 603-1, third distance sensor; and 603-2, third reflective target;
7, cable pressing device; 701, pressing ring; 702, backing plate; 703, punch pin; and 704, punching hammer; and
8, thin membrane; 9, adhesive tape; and 10, triangular cable-membrane structural unit.

### DETAILED DESCRIPTION OF THE EMBODIMENTS

The present disclosure will be described in detail below with reference to the accompanying drawings and specific examples. The illustrative examples of the present disclosure and their descriptions herein serve to explain the present disclosure, instead of limiting the present disclosure.

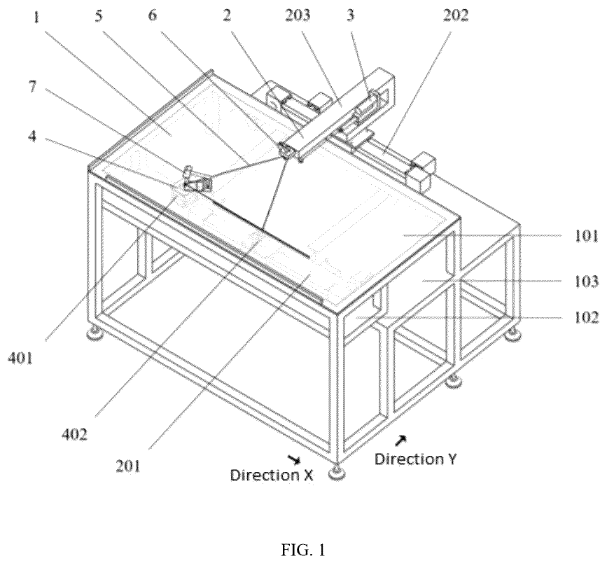

As shown in FIG. 1, a modular fabrication device for a cable-membrane structure of a thin membrane reflector antenna is provided in the examples of the present disclosure. The device includes a worktable 1, a triangular cable net shaping device 2, a cable net tension adjustment device 3, tension measurement devices 4, a triangular cable net unit 5, distance measurement devices 6, and a cable pressing device 7. The triangular cable net shaping device 2 is mounted on the worktable 1, the triangular cable net unit 5 is wound around the triangular cable net shaping device 2, and the cable net tension adjustment device 3 is fixed to the triangular cable net shaping device 2. The tension measurement devices 4 are arranged at the end portion, around which the triangular cable net unit 5 is wound, of the triangular cable net shaping device 2. The distance measurement devices 6 are placed on the worktable 1, and configured to measure a position and size of the triangular cable net unit 5 in real time. The cable pressing device 7 is fixed to cable rings of three positioning pins for the cable net of the triangular cable net unit 5 on the worktable 1, and cooperates to position and lock the triangular cable net unit 5.

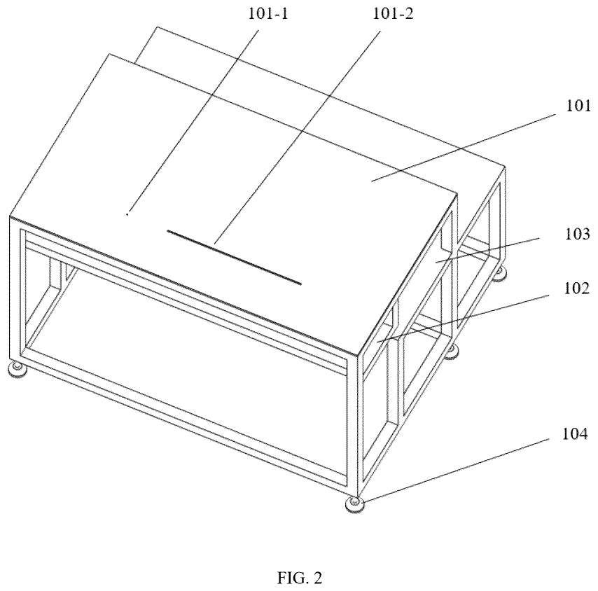

As shown in FIG. 2, the worktable 1 includes a first tabletop 101, a second tabletop 102, and a third tabletop 103, where the first tabletop 101 and the third tabletop 103 are distributed in a stepped shape, the second tabletop 102 is located below the first tabletop 101 at a front side of the worktable, and the third tabletop 103 is located at middle and rear side of the worktable. The first tabletop 101 is provided with a through hole 101-1 and an elongated slot 101-2, where a formation direction of the elongated slot 101-2 is parallel to a direction X of the worktable. Adjustable ground feet 104 are arranged at a bottom of the worktable 1. The levelness of the worktable can be adjusted through the adjustable ground feet 104, and the measurement accuracy of the tension measurement devices can be ensured.

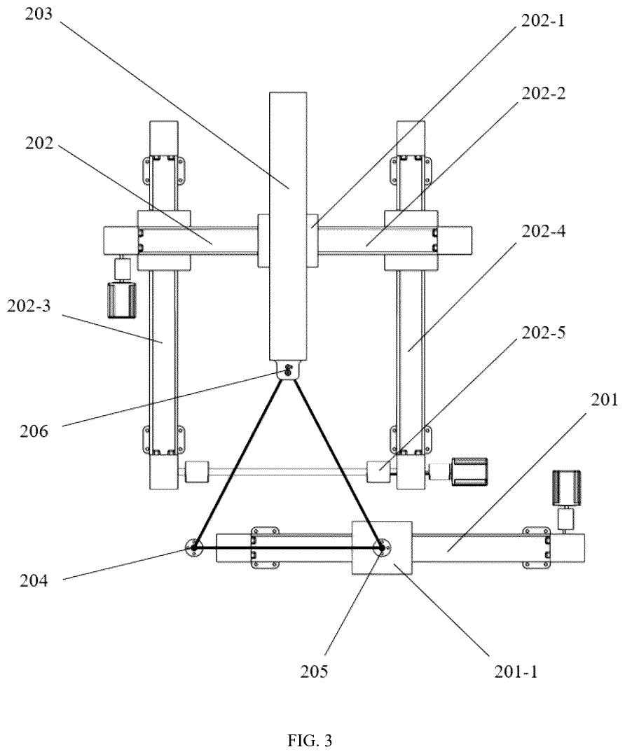

As shown in FIG. 3 and FIG. 1, the triangular cable net shaping device 2 includes a linear motion assembly 201, a planar motion assembly 202, a cantilever assembly 203, a first positioning pin 204, a second positioning pin 205, and a third positioning pin 206. Thus, the planar motion assembly can drive the cantilever assembly to slide on the first tabletop. The linear motion assembly 201 is fixed to the second tabletop 102 and located exactly below the elongated slot 101-2, and is parallel to a slot channel in a direction parallel to the direction X of the worktable. The planar motion assembly 202 is vertically connected to the cantilever assembly 203. The planar motion assembly 202 is fixed on the third tabletop 103. The cantilever assembly 203 extends out from the planar motion assembly 202, and is laid on an upper surface of the first tabletop 101. In this way, motion of the planar motion assembly drives the cantilever assembly to slide on a flat surface of the first tabletop.

The linear motion assembly 201 is fixed to the second tabletop 102, and a first sliding table 201-1 is arranged on the linear motion assembly 201. The first sliding table 201-1 may implement linear round-trip sliding on the linear motion assembly.

The planar motion assembly 202 includes a second sliding table 202-1, a horizontal-axis assembly 202-2, a first vertical-axis assembly 202-3, a second vertical-axis assembly 202-4, and a synchronous motion rod 202-5. The first vertical-axis assembly 202-3 and the second vertical-axis assembly 202-4 are fixed to the third tabletop 103 in parallel in a direction parallel to a direction Y of the worktable. The horizontal-axis assembly 202-2 spans two vertical-axis assemblies in a direction perpendicular to the first vertical-axis assembly 202-3. The second sliding table 202-1 is mounted on the horizontal-axis assembly, and the second sliding table 202-1 may implement linear round-trip sliding on the horizontal-axis assembly 202-2 in the direction X. The synchronous motion rod 202-5 is connected to tail ends of the two vertical-axis assemblies, so as to implement synchronous motion.

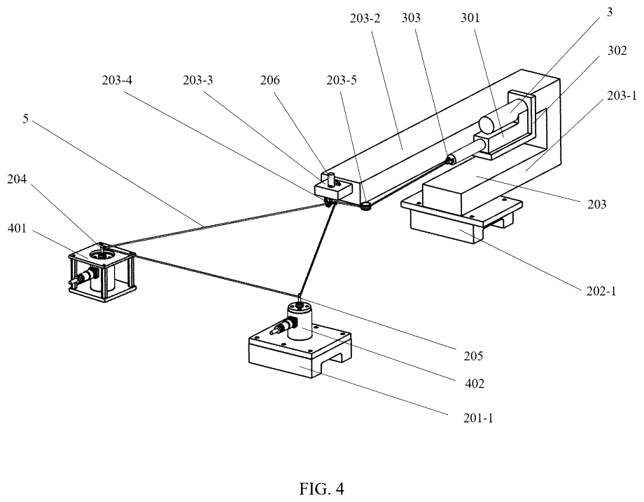

As shown in FIG. 4 and FIG. 3, the cantilever assembly 203 includes a bottom plate 203-1 of a J-shaped extension rod member, a top plate 203-2 of the J-shaped extension rod member, a fixing head 203-3, a first cable end clamp 203-4, and a fixed pulley 203-5. The top plate 203-2 of the J-shaped extension rod member is placed on the first tabletop 101, and the bottom plate 203-1 of the J-shaped extension rod member is connected to the second sliding table 202-1 of the planar motion assembly. A mounting direction of the J-shaped extension rod member is perpendicular to the horizontal-axis assembly 202-2. The fixing head 203-3 is mounted at a tail end of the top plate 203-2 of the J-shaped extension rod member, a cylindrical through hole is formed on the fixing head 203-3, the third positioning pin 206 penetrates the cylindrical through hole, and the first cable end clamp 203-4 is arranged at a tail end of the third positioning pin 206. The fixed pulley 203-5 is mounted at a corner of a front end of the top plate 203-2 of the J-shaped extension rod member. The cable net tension adjustment device 3 is arranged at the side at which the top plate 203-2 of the J-shaped extension rod member is located.

The cable net tension adjustment device 3 includes a traction device 301, a fixing frame 302, and a second cable end clamp 303. The fixing frame 302 is fixed at one side of a longer end of the J-shaped extension rod member 203-1, and the traction device 301 is mounted on the fixing frame 302. A traction direction is the direction Y of the worktable. A head portion of the traction device is provided with the second cable end clamp 303 configured to clamp the cable. The traction device has the function of providing a traction force, so as to adjust and maintain tension of the cable net.

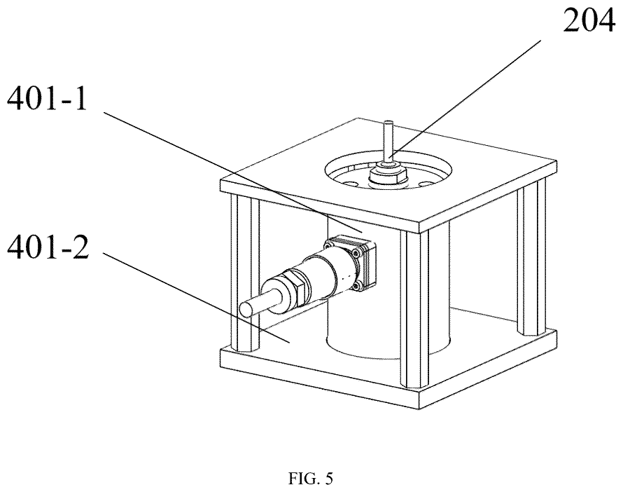

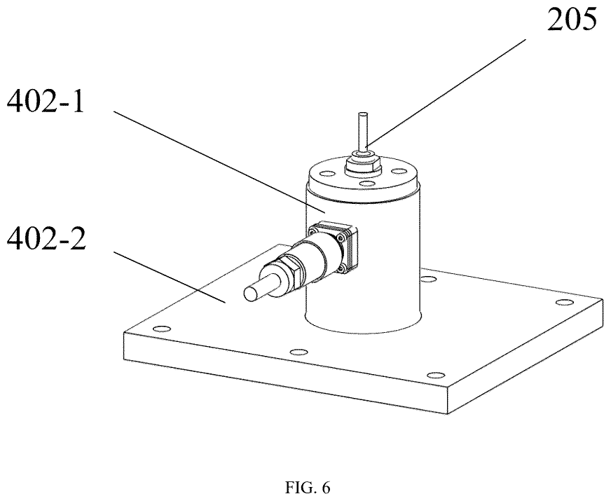

As shown in FIG. 5, FIG. 6, and FIG. 2, the tension measurement device 4 includes a first tension measurement device 401 and a second tension measurement device 402. The first tension measurement device 401 is fixed to a position exactly below the through hole 101-1 of the first tabletop 101 through the fixing support 401-2. A first tension measurement sensor 401-1 is mounted on the first tension measurement device 401, and the first positioning pin 204 is in threaded connection to a top of the first tension measurement sensor.

As shown in FIG. 6, the second tension measurement device 402 is mounted on the first sliding table 201-1 of the linear motion assembly 201 through a fixing base 402-2, and the fixing base 402-2 is provided with a second tension measurement sensor 402-1. The second positioning pin 205 is in threaded connection to a top of the second tension measurement sensor, and a top end of the second positioning pin 205 penetrates out of the elongated slot 101-2.

Arrangement directions of the first positioning pin 204, the second positioning pin 205, and the third positioning pin 206 are perpendicular to the first tabletop 101.

Each of the first tension measurement sensor 401-1 and the second tension measurement sensor 402-1 performs measurement in an X-axis direction and a Y-axis direction, and the fixing orientations of the first tension measurement sensor and the second tension measurement sensor are to align the X-axis direction with the direction X of the worktable.

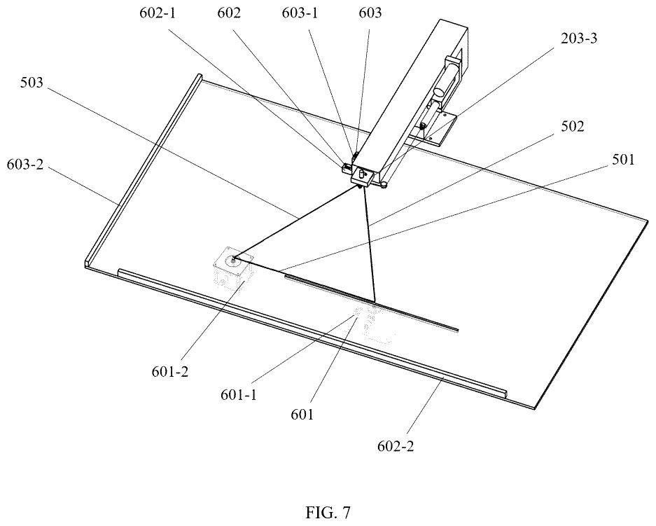

As shown in FIG. 7, one end of the cable of the triangular cable net unit 5 is clamped by the first cable end clamp 203-4, and then wound around the third positioning pin 206, the first positioning pin 204, the second positioning pin 205, and the third positioning pin 206 in sequence, and then a triangular cable net is formed. The other end of the cable is wound around the fixed pulley 203-5, and then clamped by the second cable end clamp 303. For clarity, the portion, between the first positioning pin 204 and the second positioning pin 205, of the triangular cable net unit is named as a first cable segment 501, the portion, between the second positioning pin 205 and the third positioning pin 206, of the triangular cable net unit is named as a second cable segment 502, and the portion, between the third positioning pin 206 and the first positioning pin 204, of the triangular cable net unit is named as a third cable segment 503. Three cable segments are tensioned to form the triangular cable net.

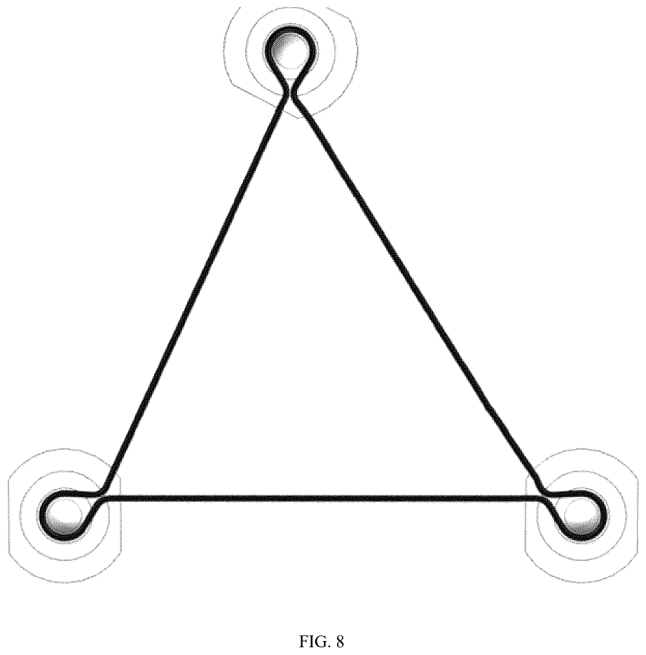

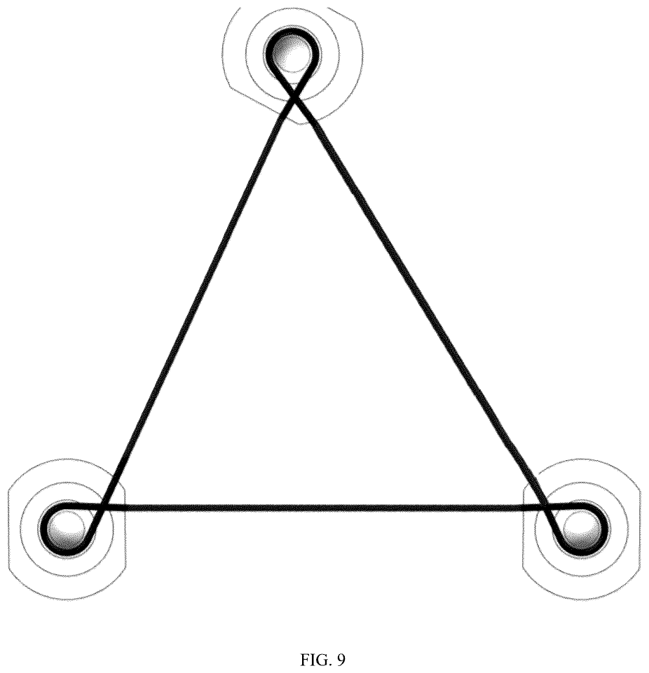

The triangular cable net unit 5 may be wound around the positioning pins in an external winding mode by enabling the cable to be wound around external sides of the positioning pins in sequence, as shown in FIG. 8. The triangular cable net unit may alternatively be wound around the positioning pins in a cross winding mode by enabling the cable to be crossed at the positioning pins, as shown in FIG. 9.

Under the coordinated motion of the linear motion assembly 201 and the planar motion assembly 202, the second positioning pin 205 and the third positioning pin 206 may move to required locations through the triangular cable net shaping device 2, and form three vertices of the triangle along with the first positioning pin 204. Thus, the triangle is shaped.

The cable net of the triangular cable net unit 5 is tensioned through the three positioning pins, and a triangular structure in a tensioned state is formed. Moreover, the first positioning pin 204 at the top of the first tension measurement device 401 is positioned and mounted through the through hole 101-1 of the first tabletop 101. The second positioning pin 205 at the top of the second tension measurement device 402 is limited in the elongated slot 101-2 of the first tabletop 101, so as to limit linear movement of the second positioning pin.

The cable net tension adjustment device 3 is fixed to one side of the cantilever assembly 203, connected to the cable net of the triangular cable net unit 5, and configured to provide a traction force and a cable net tension adjustment capability.

As shown in FIG. 7, the distance measurement device 6 includes a first distance measurement device 601, a second distance measurement device 602, and a third distance measurement device 603. The first distance measurement device 601 includes a first distance sensor 601-1 and a first reflective target 601-2. The second distance measurement device 602 includes a second distance sensor 602-1 and a second reflective target 602-2. The third distance measurement device 603 includes a third distance sensor 603-1 and a third reflective target 603-2. The first distance sensor 601-1 is arranged on the first sliding table 201-1 of the linear motion assembly 201, the first reflective target 601-2 is arranged on the fixing support 401-2 of the first tension measurement device 401, the orientation of the first distance sensor 601-1 is perpendicular to the first reflective target 601-2, and a length L1 of the first cable segment 501 is calculated by measuring a distance between the first distance sensor 601-1 and the first reflective target 601-2. The second distance sensor 602-1 is arranged at one side of the fixing head 203-3 at the tail end of the cantilever assembly 203, the second reflective target 602-2 is arranged on an edge of a front side of the first tabletop 101, parallel to the direction X of the worktable, and opposite the cantilever assembly 203, the orientation of the second distance sensor 602-1 is perpendicular to the second reflective target 602-2, and a length L2 of the second cable segment 502 is calculated by measuring a distance between the second sensor 602-1 and the second reflective target 602-2. The third distance sensor 603-1 is arranged at the one side of the fixing head 203-3 at the tail end of the cantilever assembly 203, the third reflective target 603-2 is arranged on an edge of a left side of the first tabletop 101 and parallel to the direction Y of the worktable, the orientation of the third distance sensor 603-1 is perpendicular to the third reflective target 603-2, and a length L3 of the third cable segment 503 is calculated by measuring a distance between the third distance sensor 603-1 and the third reflective target 603-2.

The second distance sensor 602-1 and the third distance sensor 603-1 are mounted at the same side of the fixing head 203-3, and distributed at the side different from the side at which the fixed pulley 203-5 is located, so as to avoid interference.

The first distance sensor, the second distance sensor, and the third distance sensor employ a non-contact measurement method, such as a laser ranging method, an ultrasonic ranging method, and radar ranging, preferably the laser ranging method.

Particularly, a length of the second reflective target 602-2 should not be smaller than a lateral movement distance of the second sliding table 202-1 on the planar motion assembly 202. A length of the third reflective target 603-2 should not be smaller than a longitudinal movement distance of the second sliding table 202-1 on the planar motion assembly 202.

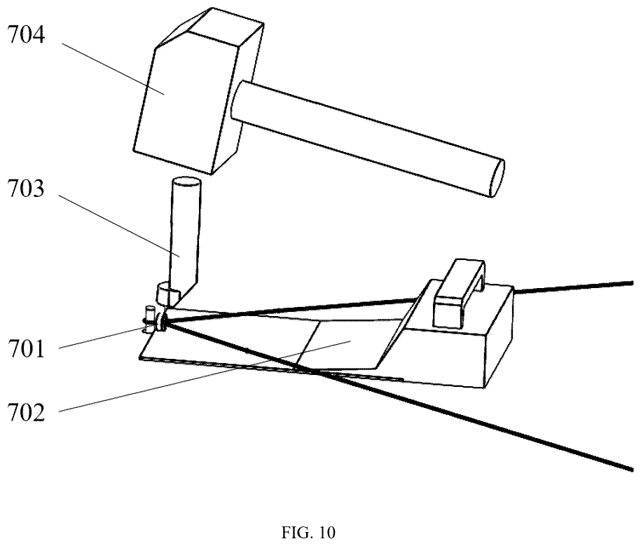

As shown in FIG. 10, the cable pressing device 7 includes a pressing ring 701, a backing plate 702, a punch pin 703, and a punching hammer 704, where the backing plate 702, the punch pin 703, and the punching hammer 704 are movable assemblies. The backing plate 702 is placed below the pressing ring 701, and the pressing ring is pressed against the cable ring through the punch pin 703 and the punching hammer 704.

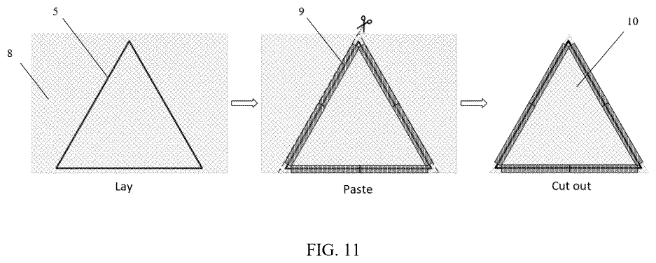

As shown in FIG. 11, a thin membrane 8, an adhesive tape 9, and a triangular cable-membrane structural unit 10 formed through pasting and cutting are shown.

A modular fabrication method is performed by employing the modular fabrication device for a cable-membrane structure of a thin membrane reflector antenna of the present disclosure as follows:
Step 1: adjustable ground feet 104 are adjusted, a first tabletop 101 of a worktable is enabled to be in a horizontal state, so as to ensure the accuracy and effectiveness of subsequent tension measurement data and distance measurement data.
Step 2: a triangular cable net shaping device 2 is controlled to adjust lengths of cable segments of a triangular cable net unit 5 according to actually-measured data of distance measurement devices, and the triangular cable net unit is shaped.

Under the control of a power source, a first sliding table 201-1 of the triangular cable net shaping device 2 is controlled to slide on a linear motion assembly 201, and drives a second positioning pin 205 to move, so that a length L1 of a first cable segment 501 of the triangular cable net unit 5 is reached. During movement, a real-time distance is measured by a first distance measurement device 601.

Under the control of the power source, a horizontal-axis assembly 202-2 of a planar motion assembly 202 of the triangular cable net shaping device is controlled to move on a first vertical-axis assembly 202-3 and a second vertical-axis assembly 202-4 separately, and a second sliding table 202-1 is controlled to slide on the horizontal-axis assembly, and drive a third positioning pin 206 on a cantilever assembly 20 to move, so that a length L2 of a second cable segment 502 and a length L3 of a third cable segment 503 are reached. During movement, real-time distances are measured simultaneously by a second distance measurement device 602 and a third distance measurement device 603.

When controlled to move, the second sliding table 202-1 may move along a horizontal axis and then a vertical axis, or along the vertical axis and then the horizontal axis, or along the horizontal axis and the vertical axis simultaneously. Under the coordinated motion of the linear motion assembly 201 and the planar motion assembly 202, the second positioning pin 205 and the third positioning pin 206 may move to required locations through the triangular cable net shaping device 2, and form three vertices of a triangle along with the first positioning pin 204. Thus, the triangular cable net unit is shaped.
Step 3: a cable is wound around three positioning pins, and the triangular cable net unit 5 is formed.

One end of the triangular cable net unit 5 is clamped by a first cable end clamp 203-4 at a tail end of the cantilever assembly 203, and one cable ring is formed at a position closest to the third positioning pin 206, sleeved with a pressing ring 701, and wound around the third positioning pin 206. Then, the cable is wound to the first positioning pin 204, and one cable ring is formed at a position closest to the first positioning pin 204, sleeved with a pressing ring 701, and wound around the first positioning pin. Finally, the cable is wound to the second positioning pin 205, and one cable ring is formed at a position closest to the second positioning pin 205, sleeved with a pressing ring 701, and wound around the second positioning pin.

After wound around the second positioning pin 205, the cable continues to be wound back to the third positioning pin 206. The other end of the cable penetrates the pressing ring 701, and then wound around the third positioning pin 206 and the fixed pulley 203-5 in sequence, and finally clamped by the second cable end clamp 303 of the cable net tension adjustment device 3. Thus, the cable wound around the three positioning pins forms the triangular cable net unit 5.
Step 4: tensioned traction is performed on the triangular cable net unit 5 by a cable net tension adjustment device 3 under the control of the power source, it is determined that each cable segment reaches set tension according to the tension measurement sensor, and the cable is positioned and locked to cable rings of the positioning pins for the cable net by a cable pressing device.

Tension inside the third cable segment 503 is calculated according to data of a first tension measurement sensor 401-1 at the first positioning pin 204, and the traction is stopped when a tension value reaches set tension T3 of the third cable segment. Then, a backing plate 702 is placed below the pressing ring 701, and the pressing ring is pressed against the cable ring through a punch pin 703 and a punching hammer 704. Thus, the tension inside the third cable segment 503 is determined.

The cable net tension adjustment device 3 releases the traction, performs traction on the triangular cable net unit 5 anew, calculates tension inside the first cable segment 501 according to data of a second tension measurement sensor 402-1 at the second positioning pin 205, and stops the traction when a tension value reaches set tension T1 of the first cable segment. The backing plate is placed below the pressing ring, and the pressing ring is pressed against the cable ring through the punch pin and the punching hammer. Thus, the tension inside the first cable segment 501 is determined.

The cable net tension adjustment device 3 releases the traction anew, performs traction on the triangular cable net unit anew, calculates tension inside the second cable segment 502 according to data of a second tension measurement sensor 402-1 at the second positioning pin 205, and stops the traction when a tension value reaches set tension T2 of the second cable segment. The backing plate is placed below the pressing ring, and the pressing ring is pressed against the cable ring through the punch pin and the punching hammer. Thus, the tension inside the second cable segment 502 is determined, and cable tension of three cable segments of the triangular cable net unit are adjusted.
Step 5: redundant cable ends are cut off from two ends of the cable, a tensioned state of the triangular cable net is kept, and the triangular cable net unit is fabricated.
Step 6: a modular triangular cable-membrane structural unit 10 is fabricated.

A rectangular thin membrane 8 is cut out, where a length of a rectangle is greater than a length of a base of the triangle, and a width of the rectangle is equal to a height of the triangle. A reverse surface of the thin membrane is upwards, and the thin membrane is flatly laid below the triangular cable net unit 5.

The three tensioned cable segments are pasted to the thin membrane through a special-purpose adhesive tape 9, and a redundant thin membrane portion is cut off along an edge of the adhesive tape after pasting is completed. Thus, a triangular thin membrane is pasted, and the modular triangular cable-membrane structural unit 10 is obtained.

The linear motion assembly 201 and the planar motion assembly 202 move back towards the first positioning pin 204 by a small distance separately. Thus, the triangular cable net unit 5 is loosened, and a triangular cable net to which the thin membrane is pasted is removed, so that fabrication of the triangular cable-membrane structural unit 10 is completed.

When in use, the triangular cable-membrane structural unit in a loosened state needs to be tensioned and hung to corresponding positions. For example, in the thin membrane reflector antenna, several triangular cable-membrane structural units may be tensioned to form an integral cable-membrane structure after being hung to one another. Each triangular cable-membrane structural unit in a tensioned state still retains a cable segment length and cable segment internal tension that are generated during fabrication.

According to the present disclosure, complicated fabrication, undesirable interchangeability, large errors, etc. of an electrode surface of an existing thin membrane reflector antenna are effectively solved. The triangular cable-membrane structural unit can be obtained through the method of the present disclosure.

The present disclosure is not limited to the above examples. On the basis of the technical solution disclosed in the present disclosure, a person skilled in the art can make some substitutions and variations to some technical features without creative efforts according to the disclosed technical contents, and these substitutions and variations fall within the scope of protection of the present disclosure.

What is claimed is:

1. A modular fabrication device for a cable-membrane structure of a thin membrane reflector antenna, comprising:
a worktable configured to fix a triangular cable net shaping device and positioning pins penetrating a tabletop and configured to tension a cable;
the triangular cable net shaping device configured with a linear motion assembly, a planar motion assembly, and a cantilever assembly, and configured to shape the cable of a triangular cable net unit;
the triangular cable net unit wound around the positioning pins of the triangular cable net shaping device through the cable separately, and tensioned into a triangular cable net having balanced tension;
a cable net tension adjustment device fixed to the triangular cable net shaping device, and configured to provide a traction force and adjustment tension for the cable net of the triangular cable net unit;
tension measurement devices fixed to the worktable and the linear motion assembly of the triangular cable net shaping device respectively, and configured to measure cable tension in an X-axis direction and a Y-axis direction of the worktable through tension measurement sensors;
distance measurement devices fixed to the worktable and the triangular cable net shaping device respectively, and configured to measure distances of cable segments of the triangular cable net unit;
a cable pressing device configured to position the cable and lock the cable to cable rings of the positioning pins for the cable net of the triangular cable net unit; and
a thin membrane and an adhesive tape, configured to paste the triangular cable net unit fabricated and form a modular triangular cable-membrane structural unit.

2. The modular fabrication device for a cable-membrane structure of a thin membrane reflector antenna according to claim 1, wherein the worktable comprises a first tabletop and a third tabletop distributed in a stepped shape, a second tabletop is arranged below a front side of the first tabletop, the first tabletop is provided with a through hole and an elongated slot parallel to a direction X of the worktable, and adjustable ground feet are arranged at a bottom of the worktable.

3. The modular fabrication device for a cable-membrane structure of a thin membrane reflector antenna according to claim 1, wherein the linear motion assembly of the triangular cable net shaping device is fixed to a second tabletop of the worktable and located exactly below an elongated slot, and is parallel to a slot channel; the planar motion assembly is fixed to a third tabletop of the worktable, and a first sliding table is arranged on the planar motion assembly; and the planar motion assembly is vertically connected to the cantilever assembly, and the cantilever assembly extends out from the planar motion device, and is laid on an upper surface of a first tabletop of the worktable.

4. The modular fabrication device for a cable-membrane structure of a thin membrane reflector antenna according to claim 1, wherein the planar motion assembly comprises a second sliding table, a horizontal-axis assembly, a pair of vertical-axis assemblies, and a synchronous motion rod; the one pair of vertical-axis assemblies are fixed to a third tabletop of the worktable in parallel in a direction parallel to a direction Y of the worktable; the horizontal-axis assembly spans two vertical-axis assemblies in a direction perpendicular to a first vertical-axis assembly; the second sliding table is slidably connected to the horizontal-axis assembly; and the synchronous motion rod is connected to tail ends of the one pair of vertical-axis assemblies.

5. The modular fabrication device for a cable-membrane structure of a thin membrane reflector antenna according to claim 1, wherein the cantilever assembly comprises a J-shaped extension rod member, a top plate of the J-shaped extension rod member is placed on a first tabletop, a bottom plate of the J-shaped extension rod member is connected to a second sliding table of the planar motion assembly, a fixing head is arranged at a tail end of the top plate of the J-shaped extension rod member, and the positioning pins configured to tension the cable penetrate the fixing head.

6. The modular fabrication device for a cable-membrane structure of a thin membrane reflector antenna according to claim 1, wherein the cable net tension adjustment device is arranged at one side of the cantilever assembly, and the cable net tension adjustment device is connected to a second cable end clamp through a traction device, so as to clamp the cable and pull the cable in a direction Y of the worktable.

7. The modular fabrication device for a cable-membrane structure of a thin membrane reflector antenna according to claim 1, wherein each of one pair of tension measurement devices is provided with a tension measurement sensor and the positioning pin configured to tension the cable, a first tension measurement device is located on a first tabletop, and a second tension measurement device is mounted on a sliding table of the linear motion assembly; and a first positioning pin and a second positioning pin are located at tops of the tension measurement devices, the first positioning pin is positioned and mounted through a through hole of the first tabletop, and the second positioning pin is limited in an elongated slot of the first tabletop, so as to limit linear movement of the second positioning pin.

8. The modular fabrication device for a cable-membrane structure of a thin membrane reflector antenna according to claim 7, wherein the distance measurement devices comprise distance sensors and reflective targets in three pairs; a first distance sensor is mounted on a first sliding table of the linear motion assembly, and a first reflective target is fixed to the first tension measurement device; a second distance sensor and a third distance sensor are mounted on a fixing head at a tail end of the cantilever assembly separately without interference, and a second reflective target is mounted on an edge of a front side of the first tabletop, and is parallel to a direction X of the worktable; a third reflective target is arranged on an edge of a left side of the first tabletop, and is parallel to a direction Y of the worktable; and lengths of three cable segments of the triangular cable net unit are obtained by measuring distances between the distance sensors and the reflective targets respectively.

9. The modular fabrication device for a cable-membrane structure of a thin membrane reflector antenna according to claim 1, wherein the cable of the triangular cable net unit is wound around the positioning pins in an external winding mode or a crossed winding mode.

10. A modular fabrication method for the modular fabrication device for a cable-membrane structure of a thin membrane reflector antenna according to claim 1, comprising:
adjusting adjustable ground feet, and enabling a worktable to be in a horizontal state;
controlling coordinated motion of a linear motion assembly and a planar motion assembly of a triangular cable net shaping device according to actually-measured data of distance measurement devices separately, enabling a second positioning pin and a third positioning pin to move, adjusting lengths of cable segments of a triangular cable net unit along with a first positioning pin, and shaping the triangular cable net unit;
winding a cable around three positioning pins, and forming a triangular cable net;
performing, by a cable net tension adjustment device, tensioned traction on the triangular cable net unit under the control of a power source, determining that each cable segment reaches set tension according to a tension measurement sensor, and positioning and locking, by a cable pressing device, a cable to cable rings of the positioning pins for the cable net;
cutting off redundant cable ends from two ends of the cable, keeping a tensioned state of the triangular cable net, and completing fabrication of the triangular cable net unit; and
pasting the triangular cable net unit fabricated, and forming a modular triangular cable-membrane structural unit.
